(19) United States
(12) Patent Application Publication
(10) Pub. No.: US 2006/0064876 A1
(43) Pub. Date: Mar. 30, 2006

(54) Razor

(76) Inventors: Richard Lee, Taipei City (TW); Jason Cheng, Taipei City (TW)

Correspondence Address: Yi-Wen Tseng, 4331 Stevens Battle Lane, Fairfax, VA, 22033, US

(21) Appl. No.: 10/953,603

(22) Filed: Sep. 30, 2004

(51) Int. Cl. B26B 21/40

(52) U.S. Cl. 30/81; 30/34.2

(57) ABSTRACT

A razor having a base, a ceramic blade installed in the base, a plurality of ceramic rollers installed in the base at two sides of the ceramic blade. The base has a lid having a slit allowing an edge of the blade to extend through and a plurality of openings allowing portions of the rollers to extend through. The rollers are supported by at least one resilient member such that the exposed portions of the rollers can be pressed inwardly for shaving and retrieved to the original height when the pressing force is relieved.

### BACKGROUND OF THE INVENTION

The present invention relates in general to a razor structure, and more particularly, to a razor made of ceramic material that is durable, non-rusty and easily cleaned.

There are two types of razors (shavers), including the typical manual razor and electric razor. As shown in FIG. 14, the conventional manual razor comprises a handle a, a blade set b connected to one end of the handle a, and tilted multiple blades c installed in the blade set b.

FIG. 15 shows a conventional electric razor that includes a handle d and a blade set e mounted to one end of the handle d. The handle includes a power source, a driving motor and a gear f, and the blade set e includes a metal blade g driven by the gear f The blade set e further comprises a mesh cover h.

Both of the manual and electric razors as shown in FIGS. 14 and 15 both is provide shaving effect. However, the manual razor is difficult to clean since the shaved beard or hair is easily stuck between the blades c, while the electric razors are often lack of water-proof structure for the power source and the driving motor, so that the user can only clean it by using brush. Further, as the mesh cover h is required for attaching the electric razor to the skin of the user, the mesh cover h is easily worn out for frequent use. In addition, the blades c and g are both made of metal which will be rusted and blunted to scratch the user or cause pain during shaving.

### BRIEF SUMMARY OF THE INVENTION

To resolve the above drawbacks, a razor made of ceramic material is provided. The razor is durable and easily cleaned. In addition, the razor will not be oxidized even under a humid environment.

The razor as provided includes a base, a ceramic blade installed in the base, a plurality of ceramic rollers installed in the base at two sides of the ceramic blade. The base has a lid having a slit allowing an edge of the blade to extend through and a plurality of openings allowing portions of the rollers to extend through. The rollers are supported by at least one resilient member such that the exposed portions of the rollers can be pressed inwardly for shaving and retrieved to the original height when the pressing force is relieved.

### BRIEF DESCRIPTION OF THE DRAWINGS

The above objects and advantages of the present invention will be become more apparent by describing in detail exemplary embodiments thereof with reference to the attached drawings in which:

FIG. 1 shows a perspective view of one embodiment of a razor;

FIG. 1a shows a perspective view of another embodiment of a razor;

FIG. 2 is a top view of FIG. 1;

FIG. 2a is a top view of FIG. 1a;

FIG. 3 is an exploded view of FIG. 1;

FIG. 4 is a cross sectional view of FIG. 1;

FIG. 5 is an exploded view of FIG. 1a;

FIG. 6 is a cross sectional view of FIG. 1a;

FIG. 7 shows an application of the razor as shown in FIG. 1;

FIG. 8 shows another application of the razor as shown in FIG. 1;

FIG. 9 is a cross sectional view showing the application status of the razor as shown in FIG. 1;

FIG. 10 is an exploded view of another embodiment of a razor;

FIG. 11 is a cross sectional view of FIG. 10;

FIG. 12 is an exploded view of another embodiment of a razor;

FIG. 13 is a cross sectional view of FIG. 12;

FIG. 14 shows a conventional manual razor; and

FIG. 15 shows a conventional electric razor.

### DETAILED DESCRIPTION OF THE INVENTION

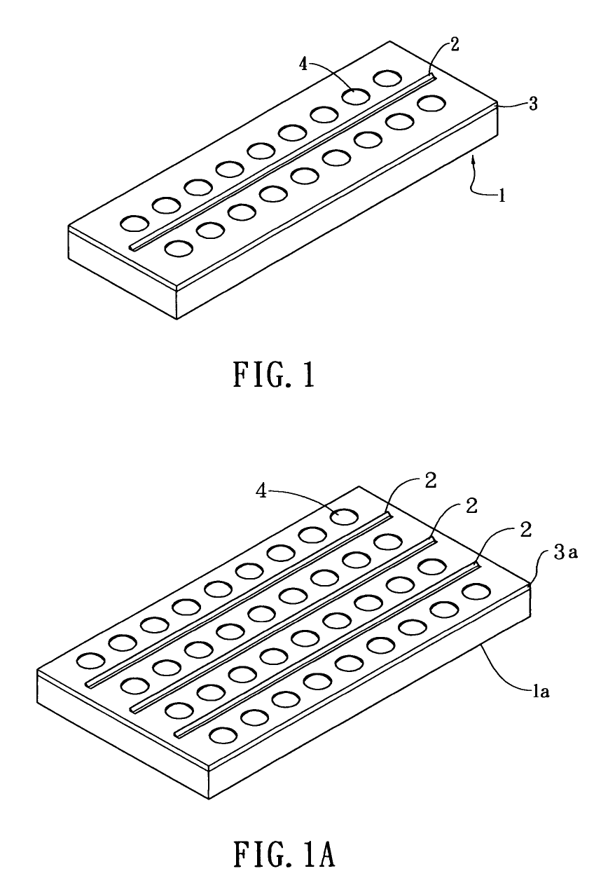

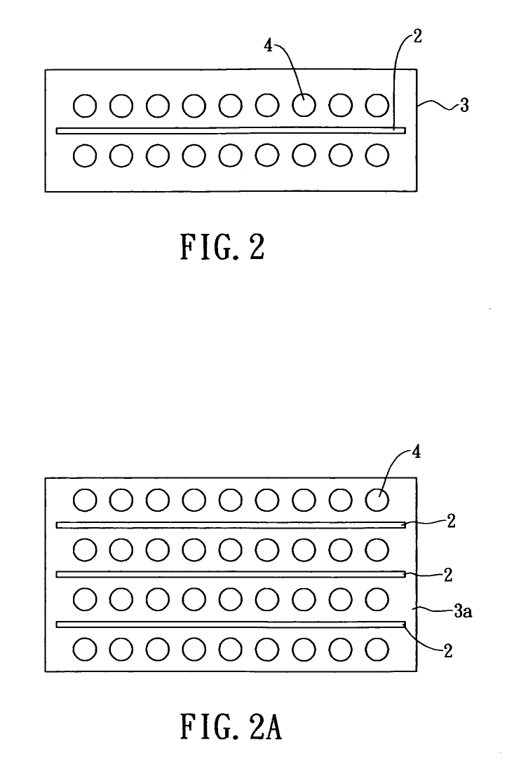

FIGS. 1 to 6 show several embodiments of razors provided by the present invention. In each embodiment, the razor includes a base 1, a blade 2, a cover 3 and a plurality of bearings 4. The razor is made of ceramic material which provides the durable, non-rusted and easily cleaned features.

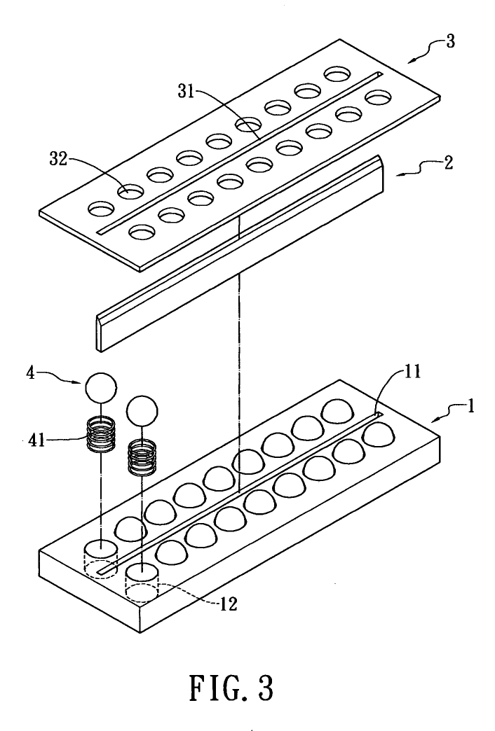

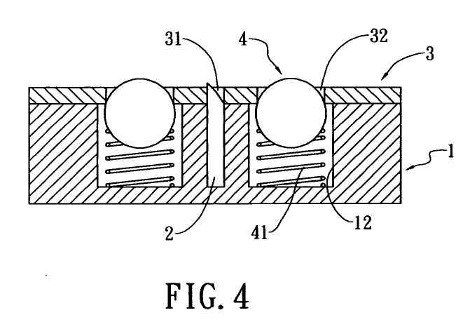

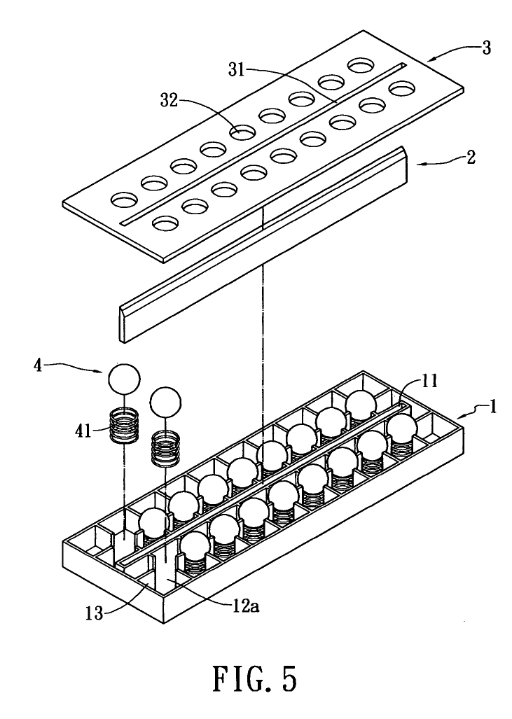

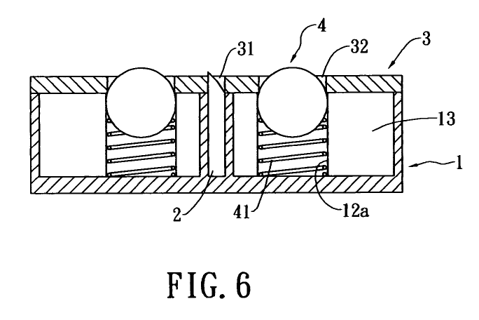

The base 1 includes a long slot 11 extending along an elongate direction thereof, and a plurality of cavities 12 along each side of the slot 11. The cross sections of the cavities 12 are shown in FIGS. 3 and 4. Alternatively, the cavities is 12 may also be replaced by a plurality of spaces 12a defined by a plurality of positioning plates 13 as shown in FIGS. 5 and 6.

The blade 2 is inserted into the slot 11 of the base 1. The blade 2 is preferably fabricated from ceramic material.

The cover 3 is mounted on top of the base 1. The cover 3 has an elongate slit 31 and a plurality of openings 32 aligned with the slot 11 and the cavities 12 or the spaces 12a. Preferably, the edge of the blade 2 inserted in the slot 11 extends over the cover 3, and the diameter of the openings 32 is smaller than that of the cavities 12 or the spaces 12a.

Each of the cavities 12 or the spaces 12a is filled with a roller or ball bearing 4 made of ceramic material. In one embodiment, a resilient member 41 such as a spring, a sponge or a silicone gel is installed under each roller 4. The diameter of each opening 32 is smaller than that of the rollers 4, such that only a portion of the rollers is exposed over the cover 3. Preferably, the height of the exposed portion of the rollers 4 is higher than the exposed edge of the blade 2 without external force.

The numbers of the blade 2, the rollers 4 can be varied according to the dimensions of the base 1a and the cover 3a.

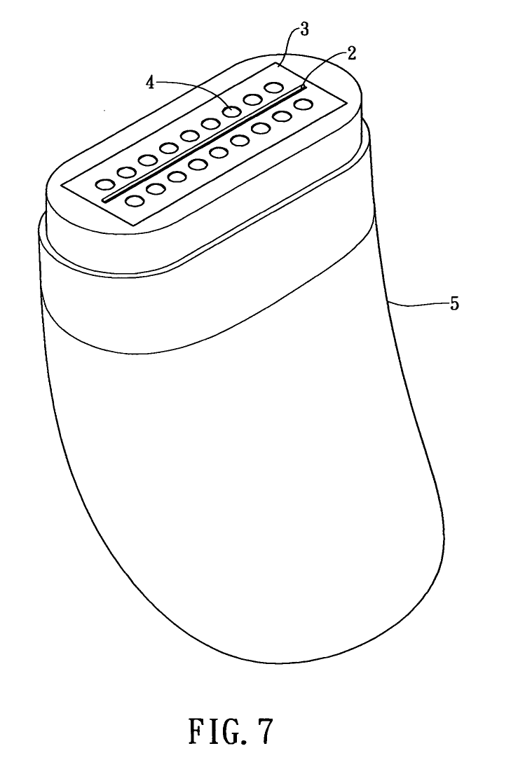

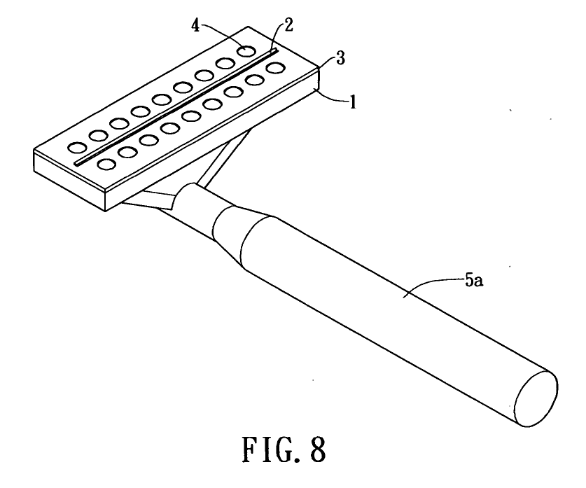

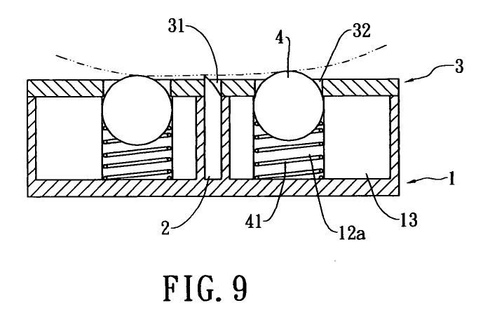

Referring to FIGS. 7-9, the razor can be mounted to a handle 5 or 5a with the exposed blade edge 2 and rollers 4 distal to the handle 5 or 5a, such that the user can hold the handle and attached the exposed blade edge 2 and rollers 4 to the skin area for shaving. Before pressing the razor towards the skin area, the exposed portion of the rollers 4 outstands the exposed edge of the blade 2, such that the blade edge 2 is not in contact with the skin area. By pressing the razor towards the skin area, the rollers 4 are pressed towards the skin portion as shown in FIG. 9, such that the user can shave the skin area along its curve.

As the blade 2 and the rollers 4 are made of ceramic material, a smooth surface for pushing the razor is obtained. The hardness of ceramic material provides great durability of the blade 2 and the rollers 4. In addition, the razor can be washed by water without the risk of being oxidized.

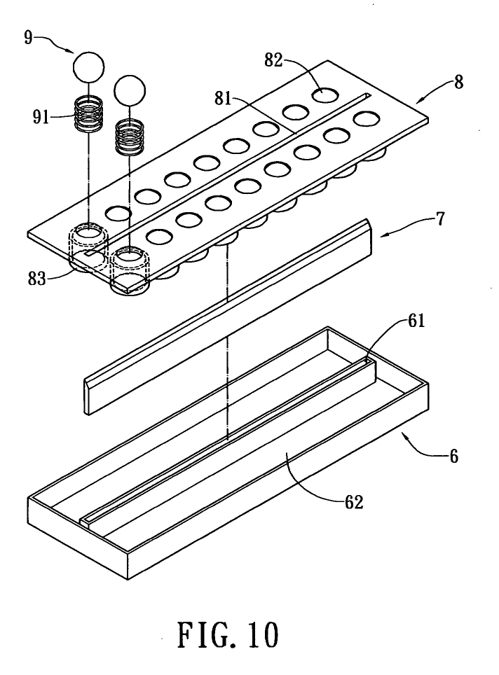

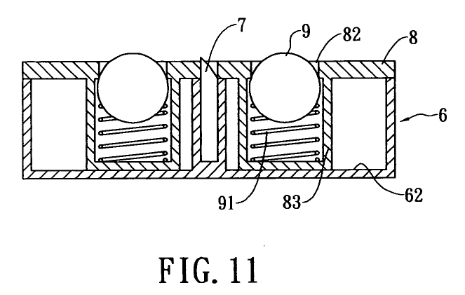

Referring to FIGS. 10 and 11, in another embodiment, a razor includes a base 6, in which an elongate slot 61 extends along an elongate axis thereof, so as to define two elongate recesses 62.

A blade 7 made of ceramic material is inserted in the slot 61. As shown in FIG. 11, the sharp edge of the blade 2 extends over slot 61.

The base 6 is covered by a cover 8 in which an elongate slit 81, is formed and aligned with the blade 7, such that the sharp edge of the blade 2 can extend over. At two sides of the elongate slit 81, a plurality of openings 82 is formed. Extending from the openings 82 are a plurality of receptacles 83 in the form of bushings.

A plurality of rollers 9 made of ceramic material is filled in the receptacles 83. Each of the receptacles 83 also includes a resilient member 91 supporting the rollers 9. The diameters of the openings 81 are slightly smaller than those of the rollers 9, such that a portion of each roller 9 is exposed over the cover 8. Preferably, the height of the exposed portions of the rollers. 9 is higher than that of the exposed tip of the blade 2.

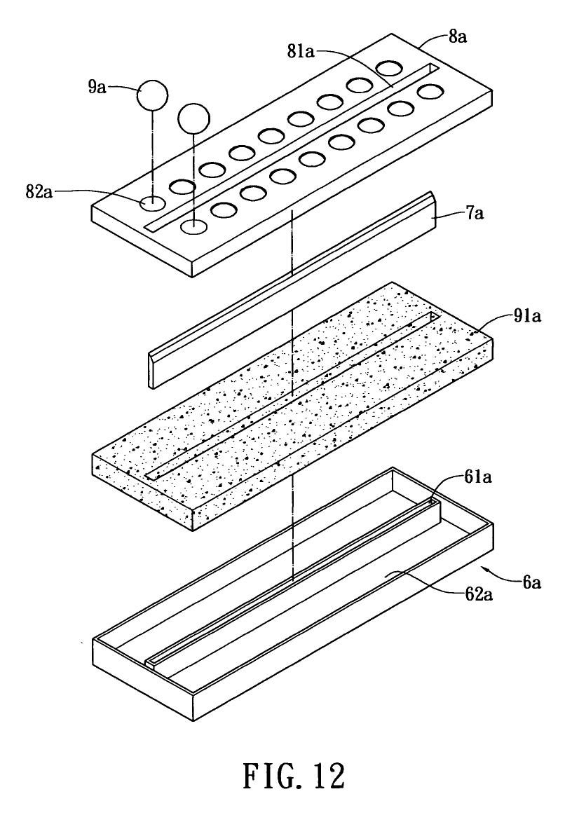

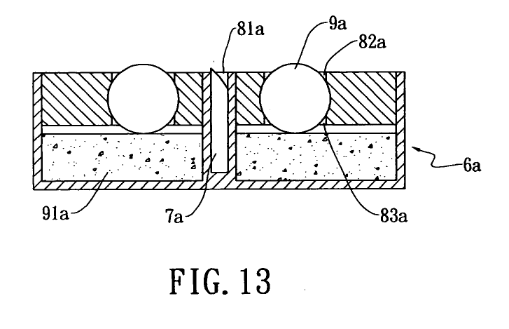

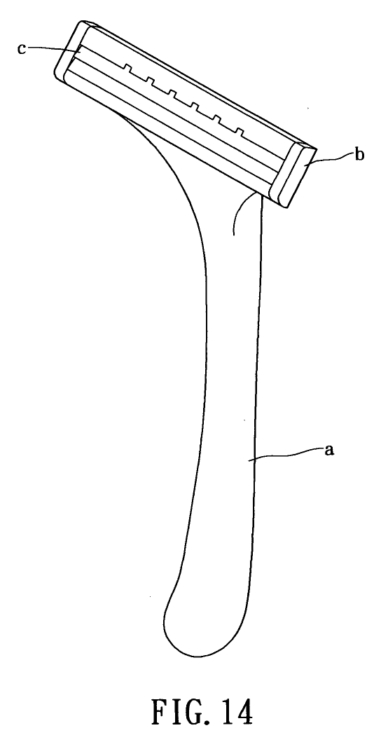

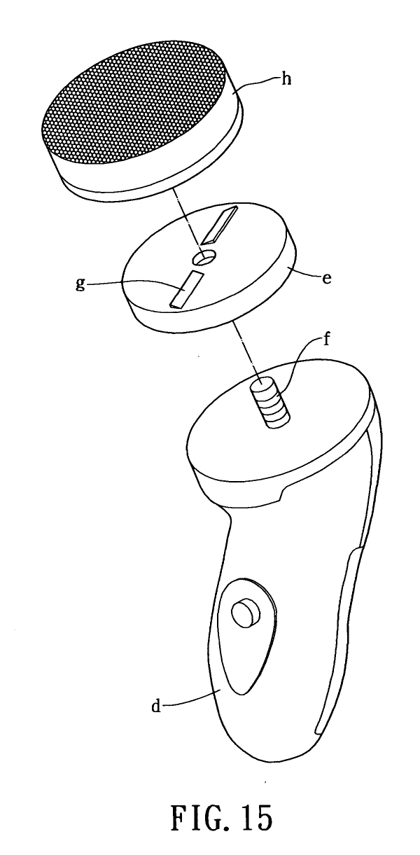

Referring to FIGS. 12 and 13, in another embodiment, the razor includes a base 6a, an elongate slot 61a extending in the base 6a along an elongate axis thereof. The slot 61a defines two elongate spaces 62a in the base 6a. The base 6a is covered by a lid 8a that has an elongate slit 81a aligned over the slot 61a, such that when a blade 7a is inserted in the slot 61a, the tip of the blade 7a extends over the lid (cover) 8a. The razor further comprises a plurality of receptacles 83a extending under the openings 82a of the lid 6a for accommodating a plurality of rollers 9a therein. The diameters of the receptacles 83a and the rollers 9a are larger than those of the openings 82a, such that only portions of the rollers 9a are exposed above the lid 6a. Preferably, the exposed rollers 9a stand higher than the exposed tip of the blade 7a.

The blade 7a and rollers 9a are preferably fabricated from ceramic materials that will not be oxidized in air and water. The razor further includes a bed of resilient member 91a disposed in the base 6a around the slot 61a. Therefore, the rollers 9a can be supported by the resilient bed 91a.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A razor, comprising:
a base;
a lid covering the base;
a blade inserted in the base, the blade having an edge extending over the lid; and
a plurality of rollers installed in the base, each of the rollers having a portion extending over the lid higher than the edge of the blade.

2. The razor of claim 1, wherein the base includes an elongate slot receiving the blade therein.

3. The razor of claim 1, further comprising a plurality of receptacles in the base for supporting the rollers therein.

4. The razor of claim 3, wherein the receptacles includes a plurality of bushings.

5. The razor of claim 3, wherein the base includes a plurality of plates defining the receptacles.

6. The razor of claim 1, further comprising a plurality of resilient members supporting the rollers in the base.

7. The razor of claim 6, wherein the resilient members include springs, sponges or silicone gels.

8. The razor of claim 1, further comprising a resilient bed in the base for supporting the rollers.

9. The razor of claim 1, wherein the lid comprises a slit for exposing the edge of the blade and a plurality of openings for exposing the portion of the rollers.

10. The razor of claim 1, wherein the blade is made of ceramic material.

11. The razor of claim 1, wherein the rollers are made of ceramic material.

12. A razor, comprising:
a base;
a ceramic blade inserted in the base and having a tip extending over the base; and
a plurality of ceramic rollers installed in the base and extending over the base at two sides of the blade.

13. The razor of claim 12, wherein the base comprises a removable top surface.

14. The razor of claim 13, wherein the top surface includes a slit exposing the tip of the blade and a plurality of openings exposing portions of the rollers.

15. The razor of claim 14, wherein the openings have a diameter smaller than that of the rollers.

16. The razor of claim 12, wherein the base comprises an elongate slot for receiving the blade.

17. The razor of claim 12, wherein the base comprises a plurality of receptacles for installing the rollers therein.

18. The razor of claim 12, further comprising a plurality of resilient members under the rollers in the base.

19. The razor of claim 12, further comprising a resilient bed under the rollers in the base.
